(19) United States
(12) Patent Application Publication
(10) Pub. No.: US 2021/0087049 A1
(43) Pub. Date: Mar. 25, 2021

(54) STIRRUPS FOR EQUESTRIAN SPORTS (Amd.)

(71) Applicant: Werner Schoeneich, Dessau-Rosslau (DE)

(72) Inventor: Werner Schoeneich, Dessau-Rosslau (DE)

(21) Appl. No.: 16/772,278

(22) PCT Filed: Dec. 19, 2018
(86) PCT No.: PCT/DE2018/000382

§ 371 Date: Jun. 12, 2020

(30) Foreign Application Priority Data
Dec. 22, 2017 (DE) 10 2017 011 963.5

(51) Int. Cl. B68C 3/00

(52) U.S. Cl. CPC B68C 3/0016; B68C 2003/0066; B68C 2003/0083

(57) ABSTRACT

Stirrups for equestrian sports attachable to a saddle with a stirrup leather strap is easy and economical to produce, and ensures the rider's foot to be securely held during riding and safely released in an emergency situation. The stirrup is surprisingly easily formed, including a single slightly curved side piece (1) and a foot rest (2) with the side piece (1) comprises an eyelet (3) on the upper end through which a stirrup leather strap is guided. The foot rest (2) is arranged on the lower end of the slightly curved side piece (1) such that it is approximately at a right angle, and carries a guiding element (4) in the form of a flat-topped pin on the end thereof facing away from the mount. The guiding element (4) points towards the end of the stirrup side piece (1) which comprises the eyelet (3), with the longitudinal extension thereof.

The invention relates to a stirrup for equestrian sports, which can be attached to the saddle with a stirrup strap.

Usually, a stirrup is arranged on each of the two long sides of a saddle that can be placed on a riding animal, wherein the length of the stirrup straps used for attachment to the saddle is adjustable.

The prior art has a large number of technical solutions for stirrups, which usually consist of a frame or bracket with a mounting receptacle for the stirrup strap and a foot rest, frequently also referred to as a step plate.

In the document DE 20 2008 016 720 U1 it is proposed that the bracket or frame of a stirrup be designed as a closed component. Other versions of stirrups are also known wherein the stirrup is designed so it can be folded out on the bracket section pointing outward in the riding position or has, according to the publication DE 20 2007 017 810 U1, a releasable elastic rubber band which is closed after the rider has mounted and the foot has been placed in the stirrup.

Also known are stirrups where a basket-like receptacle for the front part of the riding shoe or riding boot is arranged on the front section of the foot plate in order to prevent the tip of the shoe or boot from slipping out or slipping through when riding. Such a solution is shown in the publication EP 0 394 574 A1.

To improve the grip of the feet or riding boots in the stirrup while riding, it is also known to provide stirrups according to the publication DE 33 41 268 A1 with an electromagnetic holder. The document EP 2100529 A2 discloses using two magnets, wherein one magnet in the foot plate of the stirrup and the other magnet is arranged in the sole of the riding boot.

The aforedescribed proposals of the prior art serve to solve the problem of ensuring that the rider's feet are held as securely as possible in a desirable position of the rider's foot or riding boot within the stirrup. An additional aim is to facilitate the insertion of the rider's foot into the stirrup by providing movable or elastic parts of the bracket of the stirrup, as described for example in the document DE 20 2007 017 810 U1.

The solutions of the prior art cited above have certain disadvantages such as a complex production process and an at least partially complicated handling.

Another dangerous moment of equestrian sport is also not eliminated by the solutions of the prior art listed above. If a rider loses control of his riding animal, the rider can fall from the riding animal and be dragged by the riding animal when the footwear of the rider, including the rider's foot, gets caught in the stirrup. This has hitherto often caused serious, sometimes fatal injuries.

In order to counteract this danger, solutions for stirrups have been proposed in the prior art, which are intended to ensure the release of the stirrup from the rider's foot or the rider's footwear in the case of the aforedescribed danger. In the document DE 102 23 023 A1, the stirrup has the shape of a half-shell that is open on the side, which would allow the rider's foot or the rider's footwear to enter the stirrup or exit from the stirrup on the side. In the event of danger, the rider can then quickly and easily release the foot from the stirrup, since the stirrup is open on the side facing away from the horse and the tip of the foot or boot can slip out of the open half-shell without being wedged in.

A disadvantage of this solution is a complex production process, since the half-shell-shaped foot holder of the stirrup according to the document DE 102 23 023 A1, unlike the simply closed bracket of conventional stirrups, must be adapted to the size and shape of the rider's foot or the rider's footwear. In addition, the half-shell-shaped foot holder increases the cost of materials and the weight of the stirrup.

In the document DE 20 2010 000 928 U1, a safety stirrup is proposed which consists of a stable L-shaped bracket with a slightly curved elongated section and a laterally projecting section with a rigid foot rest, wherein the L-shaped bracket is open outwards, i.e. on the side facing away from the riding animal. The foot rest and footwear of the rider are equipped with at least one permanent magnet and as a counterpart with at least one ferromagnetic element or a permanent magnet in order to produce a frictional connection between the foot rest and footwear. The permanent magnet or magnets are preferably integrated in the foot rest.

Permanent magnets with a high spontaneous polarization and a large uniaxial anisotropy are to be used as permanent magnets, which have a large attractive force acting approximately perpendicular to the plane of the sole of the riding shoe. This is intended to ensure a firm and secure grip of the equestrian footwear in the stirrup during riding. Additional protection against the riding boots slipping sideways should then not be necessary. The permanent magnets should have in the radial direction only a comparatively low attractive force, so that the frictional connection is released in the event of jerky tipping movements or movements in the radial direction of the equestrian's footwear. Permanent magnets based on neodymium-iron-boron as the magnetic material or based on samarium-cobalt magnets are contemplated for use, which have a large holding force which can be set differently in the manufacturing process. The goal is to provide a differently sized frictional connection depending on the age and height of the rider.

Alternatively, the holding force can also be adjusted individually by using several permanent magnets, wherein the holding force is determined by the number and size of the magnets. When using several permanent magnets, permanent magnets with different holding forces can also be used. The holding forces can thus decrease outwardly from a center of the foot rest or foot plate with a high holding force, e.g. in the area where the balls of the rider's feet are positioned while riding.

The respective holding force of the permanent magnet or magnets is dependent on various factors, such as for example the size and weight of the rider and the intended purpose of riding (leisure activity or competitive sport in the equestrian discipline). The counterpart to the permanent magnet on the stirrup is either a second permanent magnet or a metal piece with ferromagnetic properties, which are arranged as part of the rider's footwear in the area of the shoe sole.

The significant disadvantage of the solution described in the publication DE 102 23 023 A1 is complex size selection and production as well as the disadvantageous requirement of specially equipping the equestrian footwear with additional magnetically effective elements.

The above-mentioned proposals of the prior art are in their entirety not suitable for leading to a stirrup which can be produced easily and with little effort and which enables the rider's foot or the rider's footwear to be safely released from the stirrup in the event of danger.

It is therefore the object of the invention to develop a stirrup that is simple and easy to manufacture and that guarantees a secure grip of the rider's foot or footwear of the rider and a safe release of the rider's foot or footwear of the rider in the event of danger.

This object is achieved by a stirrup with the features of claim 1. Dependent claims recite advantageous embodiments of the stirrup according to the invention.

According to the invention, the stirrup has a surprisingly simple design in that it consists of a single, slightly curved side piece and an attached foot rest, wherein the side piece has an eyelet at its upper end for feeding through a stirrup strap. The foot rest is arranged on the lower end of the slightly curved side piece at an approximately right angle thereto and has a guide element shaped as a flattened pin on its end facing away from the riding animal. The guide element points with its longitudinal extent in the direction of the end of the side piece which includes the eyelet.

The invention and its advantages will now be described in more detail with reference to an exemplary embodiment. The accompanying drawings show in

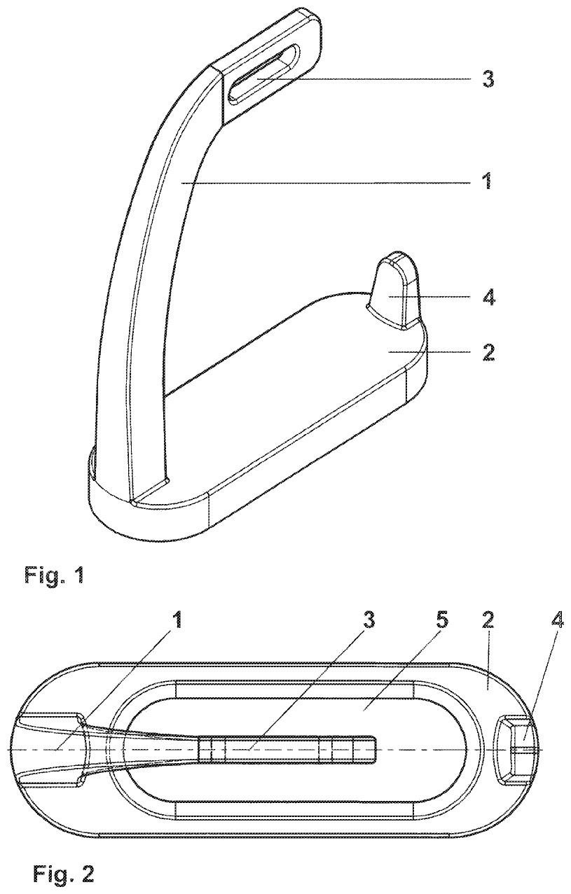

FIG. 1: a perspective view of the stirrup according to the invention,

FIG. 2: a top view of the stirrup according to the invention,

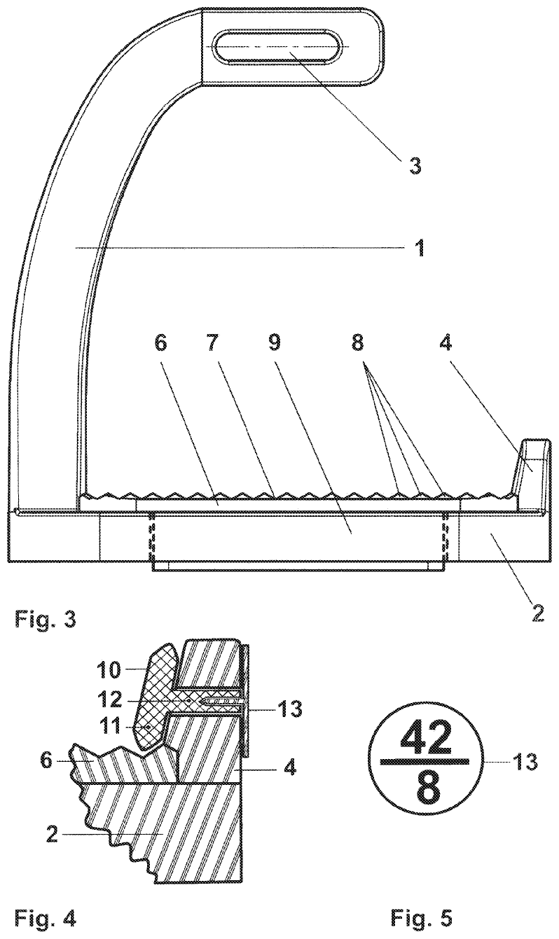

FIG. 3: a side view of the stirrup according to the invention with a tread piece,

FIG. 4 a sectional view of the guide element, and

FIG. 5 the front view of a retaining pin.

FIG. 1 shows the stirrup with its components side piece 1 and foot rest 2. The side piece 1 is slightly curved and has at one end an eyelet 3 through which a stirrup strap is guided when the stirrup is to be connected to a saddle by this stirrup strap.

The foot rest 2 is designed as a flat foot plate and is arranged on the end of the side piece 1 opposite the eyelet 3 such that this opposite end of the side piece 1 and the foot plate plane of the foot rest 2 enclose an approximately right angle. The foot plate is designed as a rectangle with profoundly rounded corners and carries a guide element 4 disposed at the end facing away from the side piece 1. The guide element 4 is designed as a flattened pin which protrudes at an approximately right angle from the surface of the foot plate of the foot rest 2. The dimensions of the elements of the stirrup according to the invention depend on the physical attributes of the rider's foot, i.e. the width of the foot or sole of the rider's footwear.

FIG. 2 shows the stirrup according to the invention in an embodiment in which the foot plate of the foot rest 2 has a recess 5. The recess 5 in the foot plate of the foot rest 2 is used on the one hand to reduce the weight and save material in the production of the stirrup, but on the other hand—as FIG. 3 shows—enables an embodiment of the stirrup with improved functionality, as briefly described below.

The bottom part 9 of a tread piece 6 can be inserted in recess 5, thereby achieving a significant improvement in holding the foot or the footwear of the rider in the stirrup. This effect can be further enhanced when the tread piece 6—as also shown in FIG. 3.—has a structured non-slip surface 7. Such a surface structure can for example be achieved with an arrangement of a plurality of truncated pyramids 8.

FIG. 4 shows the guide element 4, which has an additional clamping element 10 arranged on the side of the guide element 4 facing the side piece 1. This clamping element 10 is made of an elastic material such as, for example, natural or synthetic rubber and has a head region 11 and a shaft region 12 projecting approximately vertically from the head region 11. The head region 11 of the clamping element 10 has a planar configuration which corresponds to the surface of the guide element 4 facing the side piece 1. The shaft region 12 is clamped inside a recess of the guide element 4 and likewise has a bore-shaped recess. A retaining pin 13 is also clamped in this bore-shaped recess, thus ensuring a secure but releasable attachment of the clamping element 10 and the retaining pin 13 to the guide element 4.

The presence of the elastic clamping element 10 on the guide element 4 further improves the grip of the rider's foot or the rider's footwear in the stirrup: the clamping element 10 reinforces the contact of the rider's footwear with the guide element 4 by a slight clamping effect on the sole edge of the footwear, without impairing the safe release of the rider's foot or the rider's footwear in the event of danger. This effect of the clamping element 10 is already achieved with a thickness of the head region 11 of the clamping element 10 of a few millimeters. However, in embodiments with a greater thickness of the head region 11, the clamping element 10 can be used to adapt the stirrup according to the invention to different sizes of the rider's foot or the rider's footwear. In such cases, the head plate of the retaining pin 13 can have information about the size of the rider's footwear. In the example in FIG. 5, this information is the shoe or boot size specification 42, with an additional specification of the size 8 in the specification customary in the United Kingdom.

By designing the stirrup according to the invention with only the single side piece 1 and the guide element 4 arranged at the end of the foot rest 2 facing away from the riding animal, a stirrup has been developed which on the one hand meets the requirements of rider safety, namely to release in the event of danger the rider's foot or the rider's footwear without problems, and on the other hand ensures a sufficiently secure grip of the rider's foot or the rider's footwear during normal riding.

The design of the foot rest 2 with the tread piece 6 with structured surface 7 inserted in the recess 5, in conjunction with the guide element 4, prevents the rider's footwear from slipping into a foot posture that is detrimental to the riding process.

The design of the guide element 4 with an additional clamping element 10 further improves the grip of the rider's foot in the stirrup.

The stirrup according to the invention can be produced from metal or from sufficiently strong plastic and is simple and inexpensive due to the small number of uncomplicated construction elements. Therefore, the stirrup according to the invention can also be manufactured economically and efficiently in various sizes of the foot rest, thus eliminating complex adjustment elements otherwise required to adapt to different sizes of rider's feet or sizes of the rider's footwear.

The stirrup according to the invention has been tested on different user groups, such as children, young and more mature adults. No adverse differences in the user behavior compared to conventional stirrups were observed. The handling by the rider was identical when mounting and dismounting, and no behavior deviating from the usual behavior was observed in the posture of the rider when riding at a walking pace, trotting pace and galloping pace.

The main advantage of the stirrup according to the invention is the enormous increase in safety due to the elimination of all components of the stirrups of the prior art, which are prone to the risk of an unwanted and dangerous connection of the rider's foot or the rider's footwear to the stirrups when the riding animal shows behavior that can no longer be controlled by the rider. Because the side piece 1 is implemented only once, an open space is created between the side piece 1 and the foot rest 2 in which prevents the rider's foot or the rider's footwear from becoming wedged or jammed.

In addition, the stirrup according to the invention has significantly improved handling, since it does not require additional handling steps, such as fastening of elastic holding bands or closing of releasable connections in the event of danger, as required by some stirrups of the prior art.

### REFERENCE NUMERALS

1 side piece
2 foot rest
3 eyelet
4 guide element
5 recess
6 tread piece
7 surface
8 truncated pyramid
9 lower part
10 clamping element
11 head area
12 shaft area
13 retaining pin

1. A stirrup attachable to a stirrup strap and a saddle of a mount, comprising:
a single slightly bent side piece (1) and a foot rest (2),
wherein the side piece (1) having at its upper end an eyelet (3) for passing through the stirrup strap and the foot rest (2) is arranged at the lower end of the slightly curved side piece (1) approximately at a right angle thereto and carries at its end facing away from the riding animal a guide element (4) shaped as a flattened pin and pointing in its longitudinal extent toward the end of the side piece (1) having the eyelet (3).

2. The stirrup according to claim 1, wherein the foot rest (2) has a recess (5).

3. The stirrup according to claim 2, further comprising a tread piece (6) inserted into the recess (5) of the foot rest (2).

4. The stirrup according to claim 3, wherein a surface (7) of the tread piece (6) has a non-slip structure.

5. The stirrup according to claim 4, wherein the non-slip structure of the surface (7) of the tread piece (6) is comprised of a plurality of truncated pyramids (8).

6. The stirrup according to claim 1, wherein the guide element (4) has a clamping element (10) which is arranged on a side of the guide element (4) facing the side piece (1).

7. The stirrup according to claim 6, wherein the clamping element (10) is made of an elastic material and has a head region (11) and a shaft region (12) projecting approximately perpendicular from the head region (11), wherein the head region (11) has a planar design which corresponds to a surface of the guide element (4) facing the side piece (1) and the shaft region (12) is arranged in a clamping manner in a recess in the guide element (4).

8. The stirrup according to claim 7, wherein the shaft region (12) has a bore-shaped recess into which a retaining pin (13) clampingly engages.
